(19) United States
(12) Patent Application Publication
(10) Pub. No.: US 2024/0330672 A1
(43) Pub. Date: Oct. 3, 2024

(54) AUTOMATED GENERATION OF MITIGATION INFORMATION

(71) Applicant: INTERNATIONAL BUSINESS MACHINES CORPORATION, Armonk, NY (US)

(72) Inventors: Bhavya ., Pleasantville, NY (US); Yu Deng, Yorktown Heights, NY (US); Md Faisal Mahbub Chowdhury, Woodside, NY (US); Paulina Toro Isaza, White Plains, NY (US); Michael Elton Nidd, Zurich (CH); Amar Prakash Azad, Bangalore (IN); Harshit Kumar, Delhi (IN); Larisa Shwartz, Greenwich, CT (US)

(21) Appl. No.: 18/129,368

(22) Filed: Mar. 31, 2023

(51) Int. Cl. G06N 3/08; G06N 5/022

(52) U.S. Cl. CPC G06N 3/08; G06N 5/022

(57) ABSTRACT

A method, system, and computer program product that is configured to: train at least one model based on a corpus of historical data comprising annotated historical tickets; extract a textual sequence of a historical ticket based on the at least one trained model; determine a sentiment of the textual sequence of the historical ticket; and generate mitigation guidance to mitigate an issue in a current ticket based on the textual sequence of the historical ticket and the determined sentiment of the textual sequence of the historical ticket.

### BACKGROUND

Aspects of the present invention relate generally to automated generation of mitigation information and, more particularly, to a system, method, and computer program product for automated generation of mitigation information based on corrective action extraction and summarization.

In information technology (IT) infrastructure, a ticket may be used to classify and resolve failures or errors in IT infrastructure. In the ticket, a closing note may contain useful information about what caused the issue (i.e., failure or error) and what was done to resolve or correct the issue (i.e., corrective action) in the IT infrastructure.

### SUMMARY

In a first aspect of the invention, there is a computer-implemented method including: training, by a processor set, at least one model based on a corpus of historical data comprising annotated historical tickets; extracting, by the processor set, a textual sequence of a historical ticket based on the at least one trained model; determining, by the processor set, a sentiment of the textual sequence of the historical ticket; and generating, by the processor set, mitigation guidance to mitigate an issue in a current ticket based on the textual sequence of the historical ticket and the determined sentiment of the textual sequence of the historical ticket.

In another aspect of the invention, there is a computer program product including one or more computer readable storage media having program instructions collectively stored on the one or more computer readable storage media. The program instructions are executable to: train at least one model based on a corpus of historical data comprising annotated historical tickets; extract a textual sequence of a historical ticket based on the at least one trained model; determine a sentiment of the textual sequence of the historical ticket; and generate mitigation guidance to mitigate an issue in a current ticket based on the textual sequence of the historical ticket and the determined sentiment of the textual sequence of the historical ticket.

In another aspect of the invention, there is a system including a processor set, one or more computer readable storage media, and program instructions collectively stored on the one or more computer readable storage media. The program instructions are executable to: train at least one model based on a corpus of historical data comprising annotated historical tickets; extract a textual sequence of a historical ticket based on the at least one trained model; generate mitigation guidance to mitigate an issue in a current ticket based on the textual sequence of the historical ticket; and provide a summary of the historical data associated with the issue in the current ticket.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a computing environment according to an embodiment of the present invention.

FIG. 2 shows a block diagram of an exemplary environment in accordance with aspects of the present invention.

FIG. 3 shows a block diagram of a sequence tagger architecture in accordance with aspects of the present invention.

FIG. 4 shows a flowchart of an exemplary method in accordance with aspects of the present invention.

FIG. 5 shows a flowchart of an offline processing method in accordance with aspects of the present invention.

FIG. 6 shows a flowchart of an online processing method in accordance with aspects of the present invention.

### DETAILED DESCRIPTION

Aspects of the present invention relate generally to automated generation of mitigation information and, more particularly, to a system, method, and computer program product for automated generation of mitigation information based on corrective action extraction and summarization. According to aspects of the invention, the system, method, and computer program product may extract a problem and/or issue from a ticket and generate mitigation guidance for preventing potential failures and/or outages.

In embodiments, aspects of the present invention include a tool that recognizes a first comment in a historical ticket which indicates an issue and a second comment in the historical ticket which indicates a resolution of the issue. Further, in aspects of the present invention, if the tool recognizes the first comment in the historical ticket which indicates the issue, then the tool may proactively offer a mitigation strategy for a current ticket based on the second comment from the historical ticket. Accordingly, in aspects of the present invention, by proactively offering the mitigation strategy for the current ticket, significant time and effort is saved in addressing the issue in the current ticket. In this manner, implementations of the present invention provide an improved system, method, and computer program product for providing automated generation of mitigation information which provides a quicker and easier way to resolve ticket issues than conventional document retrieval within information technology (IT) infrastructure (i.e., IT system).

In embodiments, aspects of the present invention provide for an automatic generation of textual guidance using a neural network approach. In particular, the system, method, and computer program product identifies actions from textual data using a semi-supervised approach for expanding a training data set to extract the actions. The system, method, and computer program product also creates a silver standard corpus for the actions to provide a training set for training sequence tagger models. Conventional document retrieval within IT infrastructure does not provide any training set for training models. Further, aspects of the present invention identify corrective actions in the context of the initial issue and/or problem within the ticket. Further, in contrast to conventional document retrieval, aspects of the present invention generate guidance based on a summary of extracted corrective actions from historical tickets.

According to an aspect of the invention, the system, method, and computer program product implement automated generation of mitigation information for an issue within a ticket. For example, a computer-implemented method includes: training a plurality of sequence tagging models using a corpus of labeled service ticket data sequences; assigning interim labels to data using each of the plurality of sequence tagging models; assigning a final label to the data according to the interim labels; assigning a sentiment to the data according to a sentiment model; identifying information sequences in ticket data using the information sequence tagging model; and generating a summarization of mitigating information sequences from new ticket information.

Aspects of the present invention include a method, system, and computer program product for automated generation of mitigation information based on corrective action extraction and summarization. Conventional systems rely on simple document retrieval for identifying an issue in a ticket and identifying a corresponding resolution for the issue in the ticket. However, simple document retrieval in conventional systems is a clunky, slow, and an inefficient process. Further, by relying on document retrieval in conventional systems, it is more difficult to perform a root cause analysis. Also, predictions in conventional systems may be less accurate in comparison to the present invention which leverages a machine learning based approach using a neural network to train a plurality of models on historical tickets with closing notes.

In embodiments, by implementing methods, systems, and computer program products as described herein, extracting problems and corrective actions from tickets allows for generation of mitigation guidance for preventing potential failures and/or outages. Accordingly, implementations of the present invention provide an improvement (i.e., technical solution) to a problem arising in the technical field of resolving issues within an information technology (IT) infrastructure. In particular, embodiments of the present invention may include a neural network approach to identify issues from textual data, create a corpus or knowledge base of actions which resolve the issues, and train models using the corpus or knowledge base to generate automated mitigation guidance for future issues. Also, embodiments of the present invention may not be performed mentally or may not be performed in a human mind because aspects of the present invention comprise training machine learning models and using the trained models to improve automated mitigation for potential failures and/or outages in IT infrastructure.

Implementations of the invention are necessarily rooted in computer technology. For example, the step of training a plurality of machine learning models using a corpus of actions for resolving issues is computer-based and cannot be performed in the human mind. Training and using a machine learning model are, by definition, performed by a computer and cannot practically be performed in the human mind (or with pen and paper) due to the complexity and massive amounts of calculations involved. For example, an artificial neural network may have millions or even billions of weights that represent connections between nodes in different layers of the model. Values of these weights are adjusted, e.g., via backpropagation or stochastic gradient descent, when training the model and are utilized in calculations when using the trained model to generate an output in real time (or near real time). Given this scale and complexity, it is simply not possible for the human mind, or for a person using pen and paper, to perform the number of calculations involved in training and/or using a machine learning model.

It should be understood that, to the extent implementations of the invention collect, store, or employ personal information provided by, or obtained from, individuals (for example, users of IT infrastructure), such information shall be used in accordance with all applicable laws concerning protection of personal information. Additionally, the collection, storage, and use of such information may be subject to consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as automated mitigation code 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

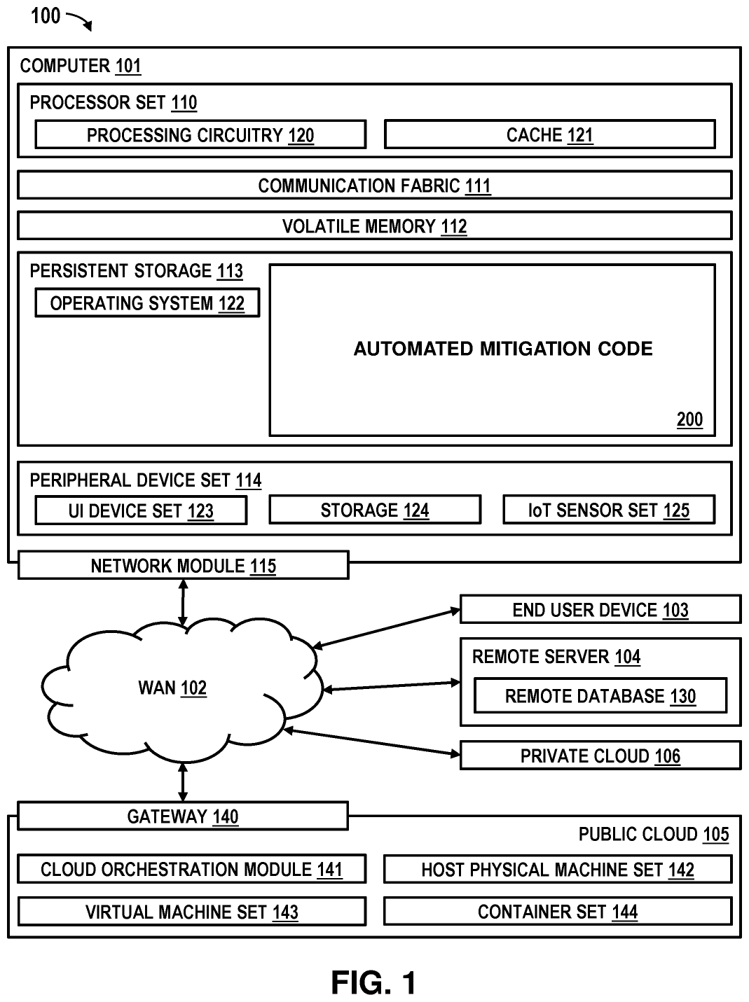

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

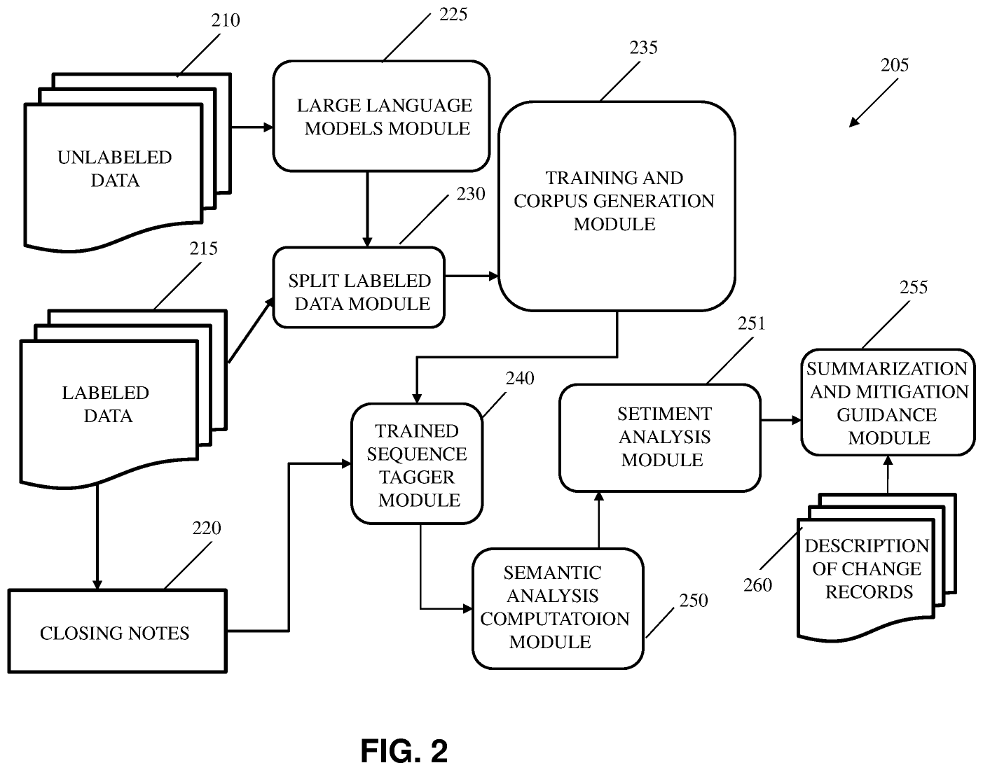

FIG. 2 shows a block diagram of an exemplary environment 205 in accordance with aspects of the invention. In embodiments, the environment 205 of a mitigation guidance system includes unlabeled data 210 which is publicly available, e.g., from public forums. Examples of public forums include enterprise forums, stackoverflow, etc. In embodiments, the environment 205 of the mitigation guidance system also includes labeled data 215, closing notes 220, large language models module 225, split labeled data module 230, training and corpus generation module 235, trained sequence tagger module 240, semantic analysis computation module 250, sentiment analysis module 251, summarization and mitigation guidance module 255, and description of change records 260. In embodiments, the environment 205 may comprise one or more instances of the computer 101 of FIG. 1.

In embodiments, large language models module 225, split labeled data module 230, training and corpus generation module 235, trained sequence tagger module 240, semantic analysis computation module 250, sentiment analysis module 251, and summarization and mitigation guidance module 255 each may comprise modules of the code of block 200 of FIG. 1. Such modules may include routines, programs, objects, components, logic, data structures, and so on that perform particular tasks or implement particular data types that the code of block 200 uses to carry out the functions and/or methodologies of embodiments of the invention as described herein. These modules of the code of block 200 are executable by the processing circuitry 120 of FIG. 1 to perform the inventive methods as described herein. The mitigation guidance system may include additional or fewer modules than those shown in FIG. 2. In embodiments, separate modules may be integrated into a single module. Additionally, or alternatively, a single module may be implemented as multiple modules. Moreover, the quantity of devices and/or networks in the environment is not limited to what is shown in FIG. 2. In practice, the environment may include additional devices and/or networks; fewer devices and/or networks; different devices and/or networks; or differently arranged devices and/or networks than illustrated in FIG. 2.

In aspects of the present invention, an input device of the mitigation guidance system receives the unlabeled data 210 from public forums and sends the unlabeled data 210 to large language models module 225. In embodiments, the large language models module 225 automatically annotates the unlabeled data 210 from public forums and sends the annotated data to the split labeled data module 230. As a non-limiting example, the large language models module 225 comprises a model that supports prompt engineering (such as Big Science Large Open-Science Open-Access Multilingual Language Model (BLOOM), Generative Pre-trained Transformer 3 (GPT-3), Fine-tuned Language Net-T5 (Flan-T5), etc.) for annotating the unlabeled data 210 from public forums. In addition, the input device of the mitigation guidance system receives labeled data 215 which includes closing notes 220 and sends the labeled data 215 which includes the closing notes 220 to the split labeled data module 230. In embodiments, the input device of the mitigation guidance system also extracts the closing notes 220 from the labeled data 215 and sends the closing notes 220 to the trained sequence tagger module 240. Before the input device sends information to the split labeled data module 230, a joint loss function may be performed on the unlabeled data 210 from public forums and the closing notes 220 by the input device to compute a distance between a current output of an algorithm and an expected output. The split labeled data module 230 splits labeled data 215 from the input device and the annotated data from the large language models module 225 into smaller data sets. In embodiments, the split labeled data module 230 sends the smaller data sets to the training and corpus generation module 235. In the training and corpus generation module 235, the smaller data sets are used to train sequence tagger models in the trained sequence tagger module 240. The training and corpus generation module 235 also generates a silver standard corpus for training the train sequence tagger models in the trained sequence tagger module 240. Further, in embodiments, the training and corpus generation module 235 iteratively adds information (i.e., as more ticket information, closing notes, and data are available) to the silver standard corpus for a training set to retrain the trained sequence tagger module 240. In embodiments, the silver standard corpus corresponds with pseudo labeled data (e.g., partly machine labeled). In embodiments, a gold standard may be manually labeled data, such as the labeled data 215. In embodiments, the sequence tagger models of the trained sequence tagger module 240 include a hybrid graphical model in supervised sequence labeling tasks such as a long term short term memory conditional random field (LSTM-CRF) model. In embodiments, the sequence tagger models of the trained sequence tagger module 240 include a masked-language model which is focused on language modeling and next sentence predictions such as a bidirectional encoder representation from transformers (BERT). However, embodiments of the trained sequence tagger module 240 are not limited to the above recited models and may include other models which train and generate a corpus based on labeled data sets.

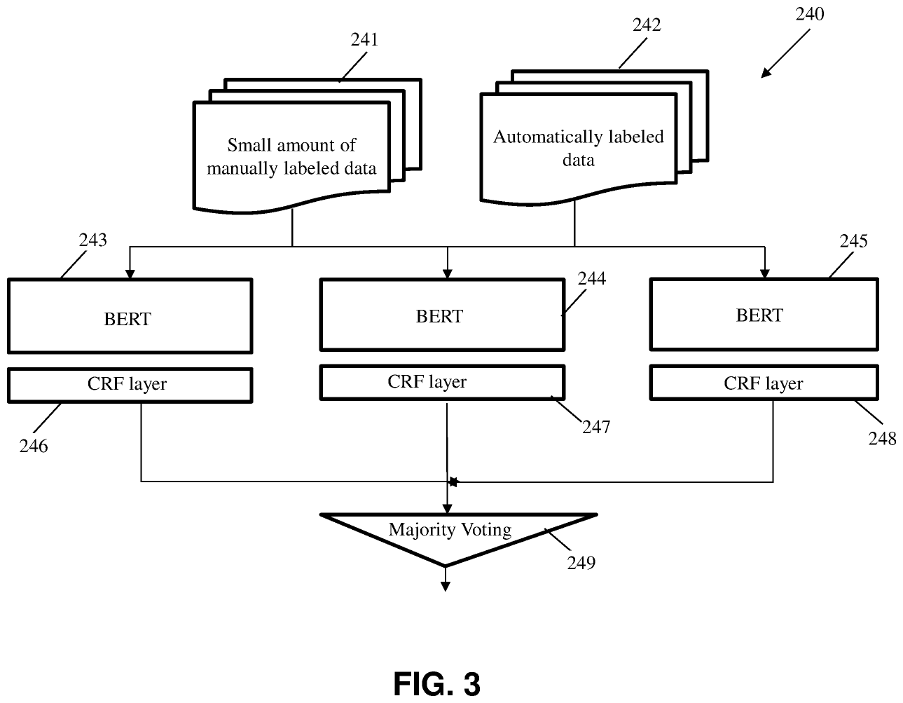

In aspects of the present invention, after the sequence tagger models of the trained sequence tagger module 240 are trained and a silver standard corpus is generated, the information from the training and corpus generation module 235 is sent to the trained sequence tagger module 240. The trained sequence tagger module 240 also receives the closing notes 220. In response to receiving the information from the training and corpus generation module 235 and the closing notes 220, the trained sequence tagger module 240 extracts a textual sequence which corresponds with the issue and the resolution of the issue (i.e., corrective action). In particular, the trained sequence tagger module 240 extracts the textual sequence based on previous training on historical information (e.g., previous issues and previous resolutions (i.e., previous corrective actions) for the previous issues from previous tickets). The trained sequence tagger module 240 extracts the textual sequence based on previous training of historical information and sends the extracted textual sequence to the semantic analysis computation module 250. In particular, the semantic analysis computation module 250 computes semantic similarity by comparing two textual pieces of information to determine if they have a similar meaning. In an example, the semantic analysis computation module 250 compares a previous issue from a previous ticket to see if there is similar meaning with a current issue in a current ticket. If there is semantic similarity between the previous issue from the previous ticket and the current issue in the current ticket, the semantic analysis computation module 250 extracts a previous resolution (i.e., previous corrective action) and provides the previous resolution (i.e., previous corrective action) to the sentiment analysis module 251. The trained sequence tagger module 240 may comprise a plurality of sequence tagger models to output annotations (i.e., extracted textual sequence) when a majority of the sequence tagger models agree. For example, the extracted textual sequence includes “services experienced intermittent errors” and “intermittent errors were resolved by performing a soft reset on the system”. The details of the architecture of the trained sequence tagger module 240 will be explained in more detail in FIG. 3.

In aspects of the present invention, the semantic analysis computation module 250 sends the extracted textual sequence and the previous resolution (i.e., previous corrective action) to a sentiment analysis module 251 using foundational models. For example, the semantic analysis module 250 using foundational models may identify whether the extracted textual sequence is a resolution which has a positive sentiment (e.g., “intermittent errors were resolved by performing a soft reset”) or whether the extracted textual sequence is an issue which has a negative sentiment (e.g., “after many attempts, the intermittent errors could not be resolved by performing known steps-issue will be escalated to supervisor”). In particular, the positive sentiment corresponds with the resolution of the issue and the negative sentiment corresponds with the issue not being resolved. Further, in embodiments, the foundational models for the sentiment analysis module 251 may be a denoising autoencoder from a transformer such as bidirectional autoencoder representations from transformers (BART). In embodiments, the foundational models for the sentiment analysis module 251 may be a text-to-text-transfer-transformer which reframes natural language processing (NLP) tasks into a unified text-to-text format in which the input and output are text strings such as T5. However, embodiments are not limited to the above recited models and may include other models which provide a sentiment analysis for the extracted textual sequence.

In aspects of the present invention, the sentiment analysis module 251 using foundational models sends the extracted textual sequence, the previous resolution (i.e., previous corrective action), and determined sentiment (i.e., positive sentiment or negative sentiment) to a summarization and mitigation guidance module 255. The summarization and mitigation guidance module 255 also receives information from a description of change records 260 to leverage a change request description for summarization model training. Therefore, the summarization and mitigation guidance module 255 receives information from the description of change records 260 and information from the sentiment analysis module 251 using foundation models and provides a summary of historical information associated with the issue. The summarization and mitigation guidance module 255 also generates mitigation guidance to mitigate the issue described in a current ticket in response to receiving information from the description of change records 260 and information from the semantic analysis module 250 using foundation models. In particular, the summarization and mitigation guidance module 255 generates the mitigation guidance to mitigate the issue described in the current ticket based on the extracted textual sequence from the trained sequence tagger module 240, the previous resolution (i.e., previous correction) extracted by the semantic analysis computation module 250, and the previous resolution (i.e., previous correction) having the positive sentiment from the sentiment analysis module 251.

FIG. 3 shows a block diagram of a sequence tagger architecture in accordance with aspects of the present invention. In particular, an architecture of the trained sequence tagger module 240 includes manually labeled data 241, automatically labeled data from public forms 242, three BERT models 243, 244, 245, CRF layers 246, 247, 248, and a majority voting component 249. In FIG. 3, manually labeled data 241 corresponds with the labeled data 215 from the training and corpus generation module 235 in FIG. 2 and the automatically labeled data 242 corresponds with the annotated data from the large language models 225 and the training and corpus generation module 235 in FIG. 2.

In aspects of the present invention, the manually labeled data 241 and the automatically labeled data 242 may be input to a plurality of BERT models 243, 244, and 245, which perform parallel processing. As stated above, each of the BERT models 243, 244, and 245 are a masked-language model which are focused on language modeling and next sentence prediction. After the BERT models 243, 244, and 245 complete parallel processing, their outputs are sent to conditional random field (CRF) layers 246, 247, and 248, respectively. Each of the CRF layers 246, 247, and 248 are a neural network layer which take neighboring sample context into account for classification tasks and implements dependencies between predictions. In FIG. 3, the output of the CRF layers 246, 247, and 248 are sent to the majority voting component 249. The majority voting component 249 outputs annotations (i.e., extracted textual sequences) of the inputs (i.e., manually labeled data 241 and the automatically labeled data 242) in which a majority of the output of the CRF layers 246, 247, and 248 agree. The annotations (i.e., extracted textual sequences) output from the trained sequence tagger module 240 are then sent to the sentiment analysis module 251. In embodiments, the annotations (i.e., extracted textual sequences) comprise issues and corrective actions from a historical ticket which are used to provide a summarization and mitigation guidance to the summarization and mitigation guidance module 255. However, embodiments are not limited to the majority voting component 249. In other embodiments, annotations (i.e., extracted textual sequences) may be output in which at least two outputs of the CRF layers 246, 247, and 248 agree. In addition, although three BERT models and CRF layers are shown in FIG. 3, any integer number N of BERT models and CRF layers may be used with the majority voting component 249 in the present invention.

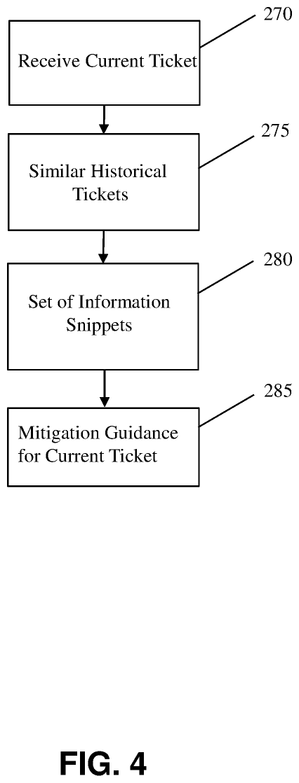

FIG. 4 shows a flowchart of an exemplary method in accordance with aspects of the present invention. Steps of the method may be carried out in the environment of FIG. 2 and are described with reference to elements depicted in FIG. 2.

At step 270, the system receives, at a trained sequence tagger module 240, a current ticket. In embodiments, and as described with respect to FIG. 2, the current ticket includes at least one current issue within the IT infrastructure. At step 275, the system performs, at the semantic analysis computation module 250, semantic similarity matching to find similar historical tickets to the current ticket. In embodiments, and as described with respect to FIG. 2, semantic similarity matching compares two textual pieces of information to determine if they have a similar meaning. The trained sequence tagger module 240 extracts the textual sequence based on previous training of historical information in historical tickets. In particular, the semantic analysis computation module 250 performs semantic similarity by comparing two textual pieces of information to determine if they have a similar meaning. In an example, the semantic analysis computation module 250 compares a previous issue from a previous (i.e., historical) ticket to see if there is similar meaning with a current issue in a current ticket. If there is semantic similarity between the previous issue from the previous (i.e., historical) ticket and the current issue in the current ticket, the semantic analysis computation module 250 extracts a previous resolution (i.e., previous corrective action) and provides the previous resolution (i.e., previous corrective action) to the sentiment analysis module 251.

At step 280, the system extracts, at the trained sequence tagger module 240, annotations (i.e., extracted textual sequences) such as issues and corrective actions from the similar historical tickets. In step 280, the system also extracts, at the semantic analysis computation module 250, the previous resolution (i.e., previous corrective action). The extracted annotations (i.e., extracted textual sequences) and the previous resolution (i.e., previous corrective action) are output as a set of information snippets. In embodiments, and as described with respect to FIG. 2, the set of information snippets include issues and corrected actions from the similar historical tickets which may aid in mitigation guidance for the current ticket. At step 285, the system provides, at the summarization and mitigation guidance module 255, mitigation guidance for the current ticket based on the set of information snippets. In embodiments, and as described with respect to FIG. 2, the mitigation guidance for the current ticket may include a summarization of historical information associated with the issue in the current ticket.

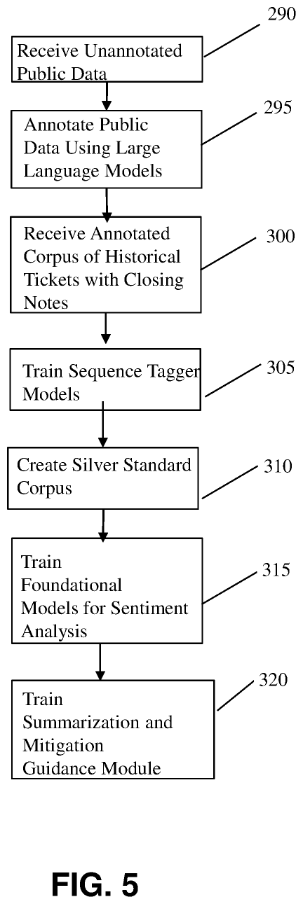

FIG. 5 shows a flowchart of an offline processing method in accordance with aspects of the present invention. Steps of the method may be carried out in the environment of FIG. 2 and are described with reference to elements depicted in FIG. 2.

At step 290, the system receives, at the unlabeled data 210, unannotated data. In embodiments, and as described with respect to FIG. 2, the unannotated data may be received from public forums, such as enterprise forums, stackoverflow, etc. At step 295, the system annotates, at the large language models module 225, the received data using large language models. In embodiments, and as described with respect to FIG. 2, the large language models may comprise a model that supports prompt engineering (such as BLOOM, GPT-3, Flan-T5, etc.) for annotating the received tickets with closing notes. At step 300, the system receives, a manually annotated corpus of historical tickets with closing notes. In embodiments, and as described with respect to FIG. 2, the annotated corpus of historical tickets with closing notes may be an optional step of FIG. 5.

At step 305, the system creates, at the training and corpus generation module 235, a silver standard corpus. In embodiments, and as described with FIG. 2, the silver standard corpus is a knowledge base with pseudo labeled data (e.g., partly machine labeled) and automatically annotated actions in tickets. At step 310, the system trains, at the training and corpus generation module 235, the sequence tagger models of the trained sequence tagger module 240. In embodiments, and as described with FIG. 2, the sequence tagger models are trained using the silver standard corpus and closing notes from historical tickets. At step 315, the system trains the sentiment analysis module 251 using foundational models. In embodiments, and as described with FIG. 2, the foundational models are fined tuned using existing sentiment analysis data. For example, the foundational models may comprise a BART model, a T5 model, a GPT-2 model, etc. At step 320, the system trains, at the summarization and mitigation guidance module 255, a model for summarization to generate mitigation guidance. In embodiments, and as described with FIG. 2, the system trains a model (e.g., transformer models such as a T5 model or a Pegasus model) for summarization and generating mitigation guidance.

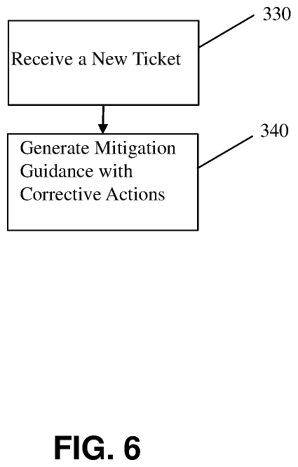

FIG. 6 shows a flowchart of an online processing method in accordance with aspects of the present invention. Steps of the method may be carried out in the environment of FIG. 2 and are described with reference to elements depicted in FIG. 2.

At step 330, the system receives, at a trained sequence tagger module 240, a new ticket. In embodiments, and as described with respect to FIG. 2, the new ticket includes at least one new issue within the IT infrastructure. At step 340, the system generates, at the summarization and mitigation guidance module 255, mitigation guidance with corrective actions for the new ticket. In embodiments, and as described with respect to FIG. 2, the mitigation guidance for the new ticket may include a summarization of historical information (e.g., at least one historical ticket) associated with the issue in the new ticket. In embodiments, the mitigation guidance with corrective actions for the new ticket is based on the trained sequence tagger module 240 extracting corrective actions from historical tickets and the semantic analysis computation module 250 extracting a previous resolution (i.e., previous corrective action) using semantic similarity.

In embodiments, a service provider could offer to perform the processes described herein. In this case, the service provider can create, maintain, deploy, support, etc., the computer infrastructure that performs the process steps of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, the invention provides a computer-implemented method, via a network. In this case, a computer infrastructure, such as computer 101 of FIG. 1, can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer 101 of FIG. 1, from a computer readable medium; (2) adding one or more computing devices to the computer infrastructure; and (3) incorporating and/or modifying one or more existing systems of the computer infrastructure to enable the computer infrastructure to perform the processes of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
training, by a processor set, at least one model based on a corpus of historical data comprising annotated historical tickets;
extracting, by the processor set, a textual sequence of a historical ticket based on the at least one trained model;
determining, by the processor set, a sentiment of the textual sequence of the historical ticket; and
generating, by the processor set, mitigation guidance to mitigate an issue in a current ticket based on the textual sequence of the historical ticket and the determined sentiment of the textual sequence of the historical ticket.

2. The method of claim 1, wherein the annotated historical tickets are related to an information technology (IT) system.

3. The method of claim 2, wherein the annotated historical tickets related to the IT system have been annotated by at least one large language model.

4. The method of claim 1, further comprising providing a summary of the historical data associated with the issue in the current ticket.

5. The method of claim 1, wherein the extracted textual sequence comprises a resolution of an issue in the historical ticket.

6. The method of claim 1, wherein the determining the sentiment of the textual sequence of the historical ticket further comprises determining whether the sentiment of the textual sequence of the historical ticket is a positive sentiment or a negative sentiment.

7. The method of claim 1, further comprising receiving the current ticket based on the issue in an information technology (IT) system.

8. The method of claim 1, wherein the at least one trained model comprises a plurality of trained models which perform parallel processing to extract the textual sequence.

9. The method of claim 8, wherein the trained models perform parallel processing and extract the textual sequence based on a majority voting agreement.

10. The method of claim 8, wherein the trained models perform parallel processing and extract the textual sequence based on an agreement of at least two models of the trained models.

11. The method of claim 1, wherein the corpus is a pseudo labeled knowledge base of the historical data.

12. A computer program product comprising one or more computer readable storage media having program instructions collectively stored on the one or more computer readable storage media, the program instructions executable to:
train at least one model based on a corpus of historical data comprising annotated historical tickets;
extract a textual sequence of a historical ticket based on the at least one trained model;
determine a sentiment of the textual sequence of the historical ticket; and
generate mitigation guidance to mitigate an issue in a current ticket based on the textual sequence of the historical ticket and the determined sentiment of the textual sequence of the historical ticket.

13. The computer program product of claim 12, wherein the annotated historical tickets are related to an information technology (IT) system.

14. The computer program product of claim 13, wherein the annotated historical tickets related to the IT system have been annotated by at least one large language model.

15. The computer program product of claim 12, further comprising providing a summary of the historical data associated with the issue in the current ticket.

16. The computer program product of claim 12, wherein the determining the sentiment of the textual sequence of the historical ticket further comprises determining whether the sentiment of the textual sequence of the historical ticket is a positive sentiment or a negative sentiment.

17. A system comprising:
a processor set, one or more computer readable storage media, and program instructions collectively stored on the one or more computer readable storage media, the program instructions executable to:
train at least one model based on a corpus of historical data comprising annotated historical tickets;
extract a textual sequence of a historical ticket based on the at least one trained model;
generate mitigation guidance to mitigate an issue in a current ticket based on the textual sequence of the historical ticket; and
provide a summary of the historical data associated with the issue in the current ticket.

18. The system of claim 17, wherein the annotated historical tickets are related to an information technology (IT) system.

19. The system of claim 18, wherein the annotated historical tickets related to the IT system have been annotated by at least one large language model.

20. The system of claim 17, further comprising determining a sentiment of the textual sequence of the historical ticket.
